(19) United States
(12) Patent Application Publication
(10) Pub. No.: US 2019/0195480 A1
(43) Pub. Date: Jun. 27, 2019

(54) ELECTRONIC DEVICE WITH ILLUMINANT

(71) Applicant: CASIO COMPUTER CO., LTD., Tokyo (JP)

(72) Inventors: Takashi TATENO, Kawasaki-shi (JP); Keiichi NAGAMINE, Tokyo (JP); Ryo UTSUNOMIYA, Tokyo (JP); Yutaro ICHIMURA, Yokohama-shi (JP)

(73) Assignee: CASIO COMPUTER CO., LTD., Tokyo (JP)

(21) Appl. No.: 16/229,455

(22) Filed: Dec. 21, 2018

(30) Foreign Application Priority Data
Dec. 25, 2017 (JP) 2017-247583

(51) Int. Cl. F21V 23/00; F21V 33/00; H05B 33/08; H05B 33/12

(52) U.S. Cl. CPC F21V 23/006; F21V 33/0056; F21Y 2115/10; H05B 33/12; H05B 33/0845

(57) ABSTRACT

An electronic device includes multiple light transmissive panels, a plurality of light emitters, and a partition plate. The multiple light transmissive panels are provided so that light emitting surfaces of the panels are not parallel to each other. The plurality of light emitters includes a first light emitter and a second light emitter. The first light emitter and the second light emitter are provided corresponding to one of the panels and each radiate light to out of the electronic device through the one of the panels. The partition plate is erected between the first light emitter and the second light emitter so that the partition plate prevents the light of the first light emitter from being incident on a position on the one of the panels where the light of the second light emitter is incident.

### CROSS-REFERENCE TO RELATED APPLICATIONS

This application is based upon and claims the benefit of priority under 35 U.S.C. 119 of Japanese Patent Application No. 2017-247583 filed on Dec. 25, 2017 the entire disclosure of which, including the description, claims, drawings, and abstract, is incorporated herein by reference in its entirety.

### BACKGROUND OF THE INVENTION

### 1. Field of the Invention

The present invention relates to an electronic device with an illuminant.

### DESCRIPTION OF THE RELATED ART

Conventionally, there is known an electronic device such as a speaker system, having a housing with faces provided with an indicator which emits light (such as a light emitting surface) and an operation unit.

As an electronic apparatus of this kind, for example, the speaker device disclosed in Japanese Patent Application Laid-Open No. 2016-32187 is provided with an indicator and an operation unit on a top face of the housing. The speaker device can be installed with the top face tilting obliquely.

### SUMMARY OF THE INVENTION

According to an embodiment of the present invention, an electronic device includes: multiple light transmissive panels which are provided so that light emitting surfaces of the panels are not parallel to each other; a plurality of light emitters which includes a first light emitter and a second light emitter, the first light emitter and the second light emitter being provided corresponding to one of the panels and each radiating light to out of the electronic device through the one of the panels; and a partition plate which is erected between the first light emitter and the second light emitter so that the partition plate prevents the light of the first light emitter from being incident on a position on the one of the panels where the light of the second light emitter is incident.

### BRIEF DESCRIPTION OF THE DRAWINGS

FIG. 1 is a perspective view of a speaker device according to an embodiment.

FIG. 2A to FIG. 2C are views of the speaker device according to the embodiment viewed from respective three directions.

FIG. 3 is a view schematically showing arrangement of speaker units in a rear case of the speaker device according to the embodiment.

FIG. 4A is a sectional view of the speaker device taken along the line IV-IV in FIG. 2B, and FIG. 4B is a detailed view of the portion A in FIG. 4A.

FIG. 5 is a perspective view of the rear case in a state where an inner case according to the embodiment is incorporated.

FIG. 6 is a perspective view of a rotary encoder mounted on a dial substrate, for explaining an internal structure of a dial type switch according to the embodiment.

FIG. 7A is a sectional view of the speaker device as in FIG. 4A, and FIG. 7B is a perspective view of the sectional view of FIG. 7A viewed obliquely from the front.

FIGS. 8A and 8B show a modification example of the embodiment. FIG. 8A is a sectional view of a speaker device as in FIG. 4A, and FIG. 8B is a detailed view of the portion B in FIG. 8A.

FIG. 9 is a view schematically showing arrangement of speaker units and bass reflex ports in a rear case according to a second modification example of the embodiment.

FIG. 10 is a view schematically showing arrangement of speaker units and passive radiators in a rear case according to a third modification example of the embodiment.

FIG. 11 is a schematic view of a speaker device according to an embodiment.

### DETAILED DESCRIPTION OF THE PREFERRED EMBODIMENTS

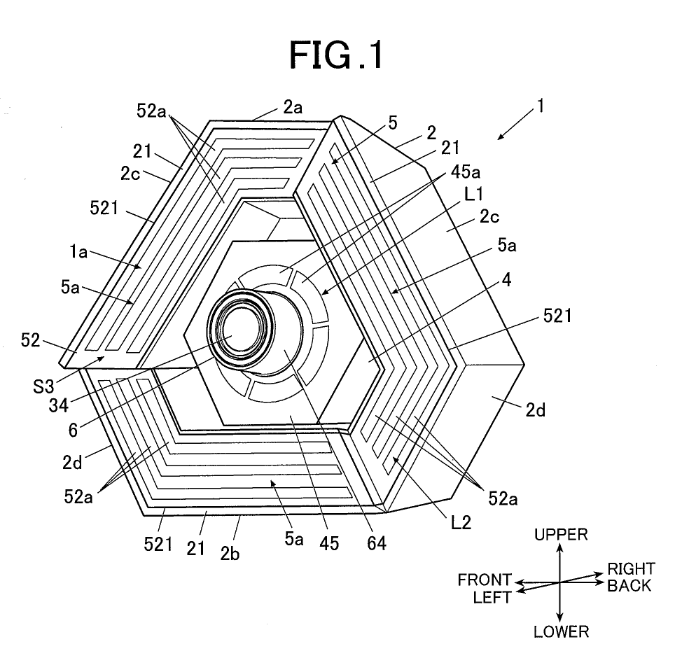

Hereinafter, embodiments will now be described with reference to FIG. 1 to FIG. 11, in which an electronic device according to the present invention is applied to a speaker device (speaker system).

The following embodiments involve various technically preferred limitations for accomplishing the present invention, however, the scope of the invention should not be limited to the embodiments and the drawings.

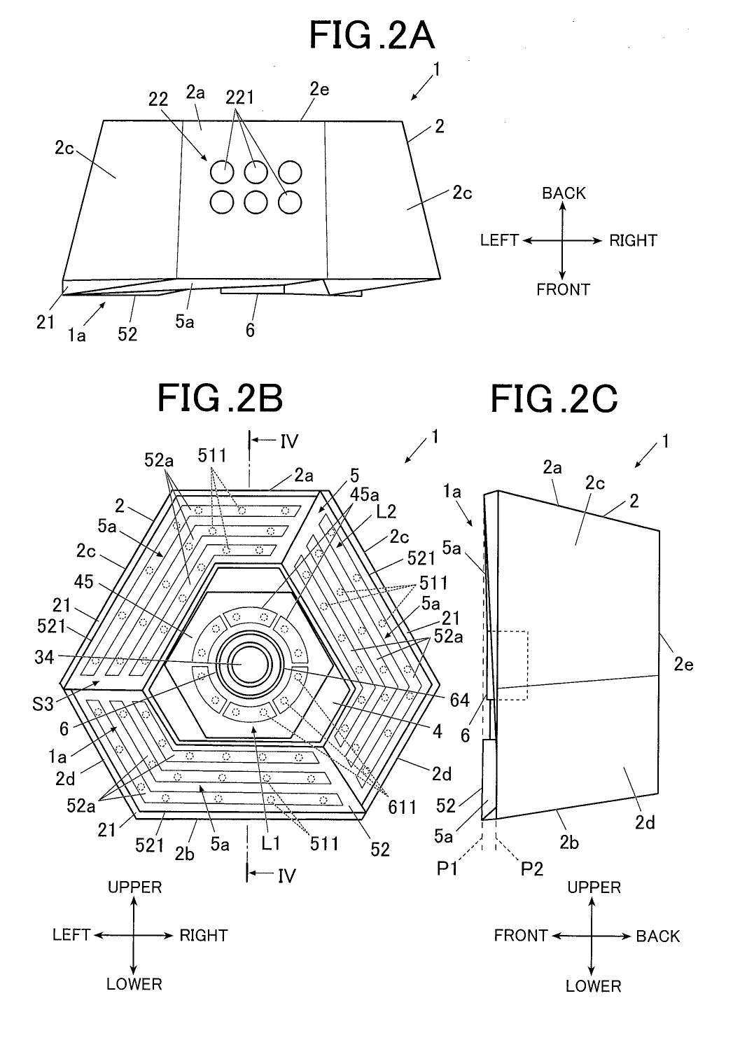

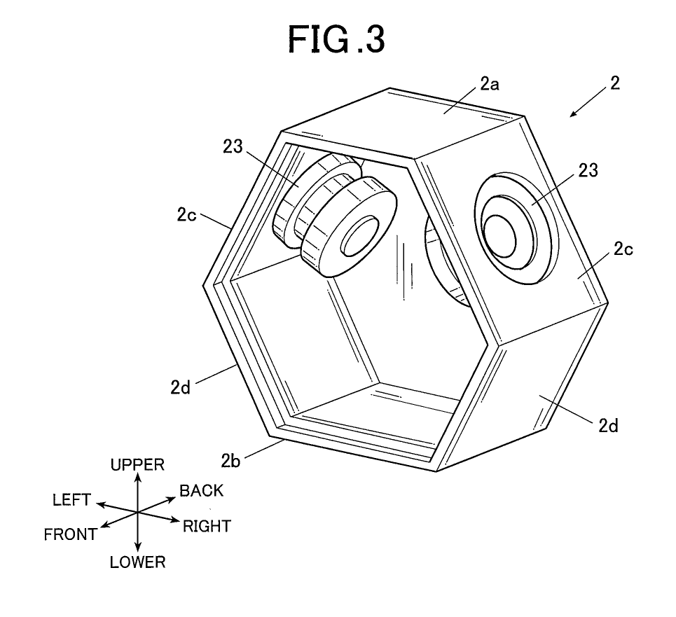

FIG. 1 is a perspective view of a speaker device 1 according to the present embodiment. FIG. 2A to FIG. 2C are views of the speaker device 1 from three directions. FIG. 2A is a plan view, FIG. 2B is a front view, and FIG. 2C is a lateral view from the right. FIG. 3 is a view schematically showing arrangement of loudspeakers 23 in a rear case 2 of the speaker device 1.

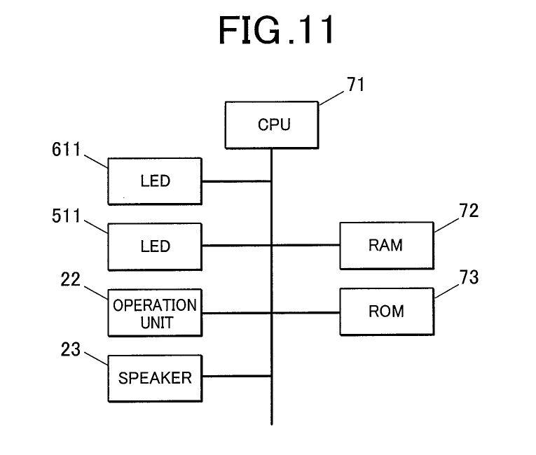

As shown in FIG. 11, the speaker device 1 is a computer including a CPU 71 (processor, controller), a RAM 72, a ROM 73, LEDs 511 (light emitters), LEDs 611 (light emitters), an operation unit 22, a loudspeaker(s) 23, and the like. The CPU 71 executes a control program stored in the ROM 73 and the RAM 72 and causes the loudspeaker 23 to output musical tones and the LEDs 511 and 611 to emit light in accordance with the operation signal output from the operation unit 22.

As shown in FIG. 1 and FIG. 2, the speaker device 1 of the present embodiment is an active speaker with a built-in amplifier and is formed in a substantially hexagonal truncated pyramid shape having a hexagonal shape when viewed from the front. The speaker device 1 is a Bluetooth speaker compliant with Bluetooth (registered trademark) of the Wireless Personal Area Network standard. The speaker device 1 can reproduce audio data received wirelessly from various digital devices which are also compatible with Bluetooth.

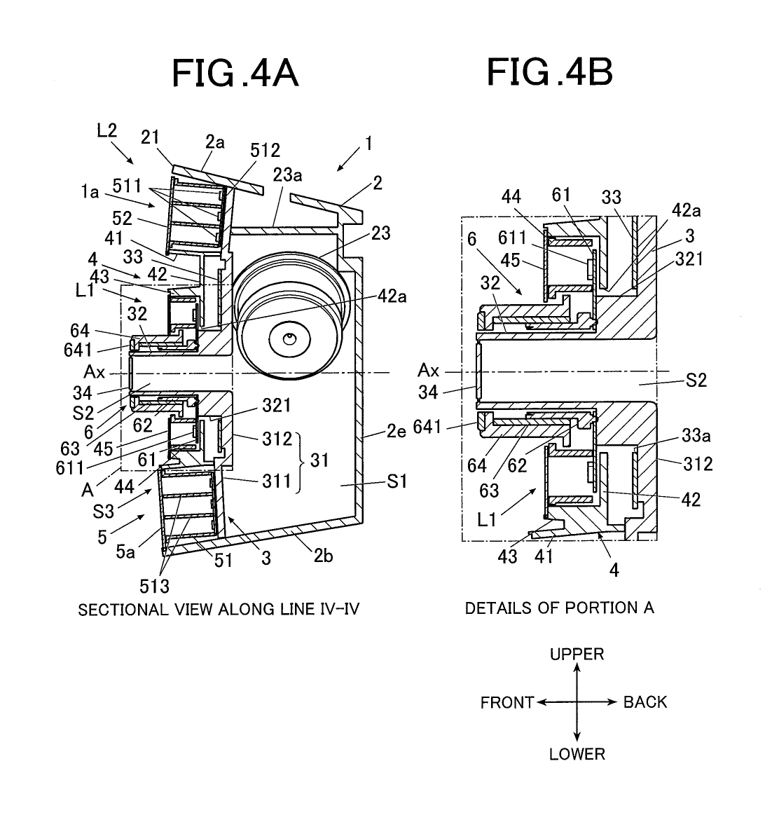

In the following, the terms “upper”, “lower”, “front”, “rear (back)”, “left”, and “right” are used to indicate directions described in the drawings, in which the front direction of the speaker device 1 is defined as a front side, and the side having the operation unit 22 described later is defined as an upper side. Further, the terms “radial direction” and “peripheral direction”, and similar terms thereof are used to indicate directions in reference to the center axis Ax of the speaker device 1 which is along the front-back direction (see FIG. 4), unless otherwise specified.

Specifically, the speaker device 1 is provided with the rear case 2 whose front side is open.

The rear case 2 is formed in a substantially hexagonal truncated pyramid shape whose hexagonal shaped section in the front view gradually decreases toward the rear.

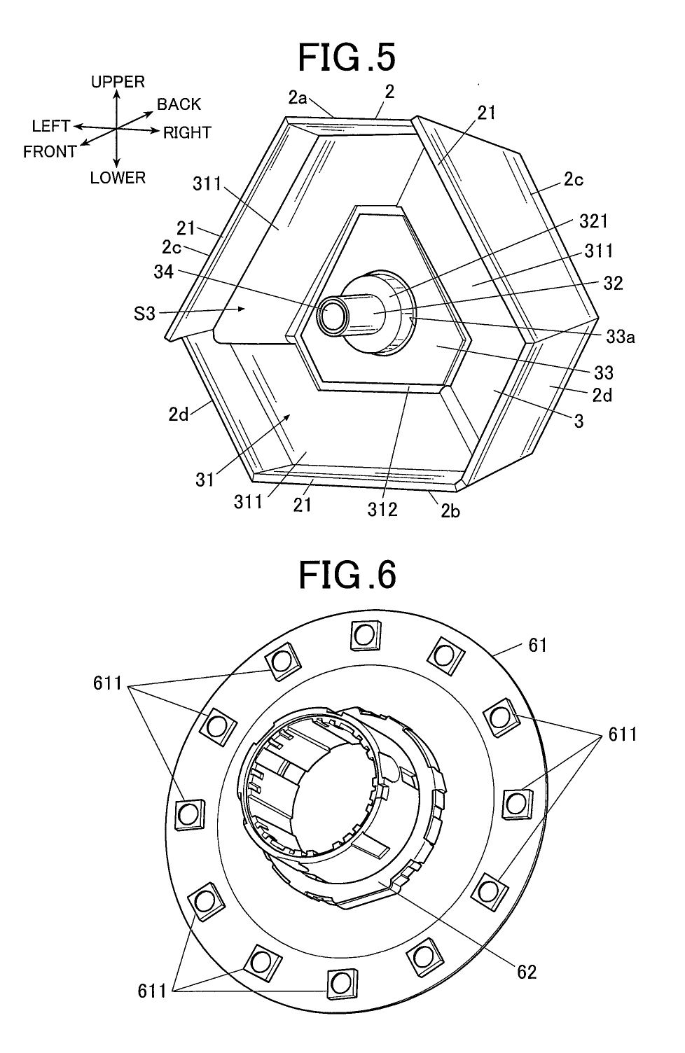

More precisely, the rear case 2 has a hexagonal shape when viewed from the front, which is three-fold rotationally symmetry with short sides and long sides alternately connected. The periphery of the front edge of an opening of the rear case 2 is formed in a sawtooth-like shape in the lateral view, since three tilt portions 21 tilting back and forth at a constant tilt angle are connected along the periphery so as to form a ring (see FIG. 5). Each tilt portion 21 extends over the central angle range of 120° when viewed from the front, which is the range from one vertex to another vertex at two points ahead of the one vertex in the present embodiment.

The rear case 2 constitutes all the surfaces composing the outer face of the speaker device 1 except for a front surface 1a, that is, the six surrounding side surfaces including the upper and lower surfaces (i.e., the upper surface 2a, the lower surface 2b, the two (left and right) upper side surfaces 2c, the two (left and right) lower side surfaces 2d), the and a rear surface (back surface) 2e. Among the six surrounding side surfaces, the upper surface 2a and the two lower side surfaces 2d are on the short sides viewed from the front, and the lower surface 2b and the two upper side surfaces 2c are on the long sides viewed from the front.

The upper surface 2a of the rear case 2 is provided with an operation unit (user interface) 22 which mainly receives various operations by a user. The operation unit 22 has multiple buttons 221. These multiple buttons 221 include, for example, a power button, a volume button, a light ON/OFF button for turning on/off the LEDs 511 and 611 described later, a pairing button for pairing of Bluetooth, a mode switching button for switching the acoustic mode, and the like. Further, the operation unit 22 is provided with various terminals such as a power supply terminal (DC jack), a USB (Universal Serial Bus) terminal, and an audio input terminal, though not shown in the drawings.

As shown in FIG. 3, each of the two (left and right) upper side surfaces 2c of the rear case 2 is provided with a loudspeaker 23 which is a speaker unit of a full range (for all frequency bands).

It should be noted that FIG. 3 is a diagram showing the arrangement of the loudspeakers 23 in the rear case 2 not accurately but schematically. To be exact, a fixing plate 23a perpendicular to the inner bottom (rear) surface of the rear case 2 is erected on the bottom surface at an edge of the upper side surface 2c side, and the loudspeaker 23 is attached to the fixing plate 23a (see FIG. 4A). A number of sound holes (not shown in the drawings) are formed in the upper side surface 2c outside of the fixing plate 23a, and sound from the loudspeaker 23 is output to an outside of the rear case 2 through these sound holes. A rib (not shown in the drawings) is erected on the outer face of the fixing plate 23a at both sides of the loudspeaker 23 in the peripheral direction. The rib closes a gap between the tilting upper side surface 2c and the fixing plate 23a.

As shown in FIGS. 1 and 2B, the lower surface 2b of the rear case 2 serves as an installation surface when the speaker device 1 is installed upright and provided with multiple rubber feet (not shown in the drawings).

The rear surface 2e of the rear case 2 serves as an installation surface when the speaker device 1 is installed horizontally, and provided multiple rubber feet (not shown in the drawings).

As described above, the outer face of the speaker device 1 is configured from the front surface 1a, the six side surfaces of the rear case 2 (the upper surface 2a, the lower surface 2b, two upper side surfaces 2c on the left and right, and the two lower side surfaces 2d on the left and right). These surfaces have different directions from each other. From these surfaces are separately selected a surface(s) (e.g., the upper side surface(s) 2c) on which the speaker(s) 23 is arranged and a surface (e.g., the front surface 1a) on which a passive radiator 34 described later is arranged, without overlapping. In the present embodiment, from these surfaces are further separately selected a surface (e.g., the upper surface 2a) on which the operation unit 22 is arranged and an installation surface (e.g., the lower surface 2b or the rear surface 2e) without overlapping each other.

The device can be more compact as a total by arranging the functional surfaces separately on the multiple surfaces of a polyhedron in this manner, compared with a device in which multiple functional surfaces are collectively arranged on one large surface.

Further, since the respective speakers 23 are arranged on the two upper side surfaces 2c which are not parallel to each other, these speakers 23 do not cancel the audio from each other.

Further, from the six side surfaces of the rear case 2, the two upper side surfaces 2c on which the speakers 23 are each arranged and the lower surface as the installation surface are separately selected from the three side surfaces on the long sides when viewed from the front. The upper surface 2a on which the operation unit 22 is arranged is selected from the three side surfaces on the short sides when viewed from the front. As a result, the device can be more compact as a total, while the surfaces having large area are secured as surfaces which require a relatively large area, such as an arrangement area for arranging the loudspeaker 23 and an installation area for stable installation.

The shape of the outer face of the speaker device 1 including the respective surfaces of the rear case 2 is not limited by the above description. For example, the six side surfaces of the rear case 2 may not tilt with respect to the front-back direction, or the shape of the rear case 2 may not be hexagonal when viewed from the front. However, in order to ensure rigidity of the rear case 2 (a speaker box), the shape of the rear case 2 viewed from the front is preferably a convex polygonal shape having five or more vertexes.

Further, the outer face of the speaker device 1 is preferably composed of six to eight surfaces which face directions different from each other. In this case, it is preferred that there are any one of the loudspeaker 23, the passive radiator 34 described later, and the user interface arranged on at least five surfaces in the outer face of the speaker device 1, and that at least one of the remaining surface(s) is the installation surface.

The multiple surfaces forming the outer face of the speaker device 1 are not limited to flat surfaces, as long as their main directions are different from each other. The surfaces may be curved surfaces, for example. The surfaces may partially have small concavo-convex portions. The whole outer face may include multiple surface portions at different angles from each other, as long as the envelope surface (the surface enveloping the multiple surface portions) is substantially flat.

Further, the present embodiment does not limit which of the multiple surfaces constituting the outer face of the speaker device 1 is selected as: the surface on which the speaker 23 is arranged; the surface on which the passive radiator 34 described later is arranged; the surface on which the operation unit 22 is arranged; and the installation surface(s), as long as the selected surfaces do not overlap each other.

FIG. 4A is a sectional view of the speaker device 1 taken along the line IV-IV of FIG. 2B. FIG. 4B is a detailed view of the portion A in FIG. 4A. FIG. 5 is a perspective view of the rear case 2 in a state where the inner case 3 described below is incorporated. FIG. 6 is a perspective view of a rotary encoder 62 mounted on a dial substrate 61 for explaining an internal structure of a dial type switch 6 described later.

As shown in FIGS. 4A and 5, the inner case 3, a front case 4, and a light-emitting unit 5 are housed inside the rear case 2.

Among them, the inner case 3 is formed in a shape having a connected plate 31 and a cylindrical portion 32. The connected plate 31 includes multiple tilt plates 311 which are connected so as to form steps. (The connected plate 31 may be referred to as a flat plate in the following, because it has a substantially flat plate shape with slight steps with respect to a reference plane when an envelope surface enveloping multiple convex portions at the front face of the speaker device 1 is set to be a reference plane.) The cylindrical portion 32 is erected from the center of the connected plate 31 toward the front. The inner case 3 is formed of a material having high heat dissipation property (thermal conductivity), such as aluminum die-cast or zinc die-cast.

The connected plate 31 is formed in a hexagonal shape corresponding to the shape of the rear case 2 (opening shape) viewed from the front. The connected plate 31 is substantially orthogonal to the front-rear direction of the rear case 2 and is in contact with the front edge of the fixing plate 23a. The connected plate 31 closes the opening of the rear case 2 at a position slightly in front of the central portion of the interior of the rear case 2 in the front-rear direction. As a result, a closed space including the loudspeaker 23 is formed by the rear case 2 and the connected plate 31 (the inner case 3). The closed space is a main air chamber S1 of the speaker device 1. In other words, the connected plate 31 (the inner case 3, a partition member) partitions the space in the rear case 2 into the main air chamber S1 and a component arrangement space S3 in which electronic components other than the loudspeakers 23 are arranged.

Almost half of the outer peripheral side of the connected plate 31 is formed by connecting (peripherally arranging) the three tilt plates 311 which tilt back and forth at a constant tilt angle along the outer periphery of the rear case 2 (arranged to forma ring). The three tilt plates 311 form sawtooth-like steps along the outer periphery of the rear case 2 when viewed in clockwise (or counterclockwise). The sawtooth-like steps correspond to the three tilt portions 21 of the rear case 2. Specifically, each of the three tilt plates 311 which tilt back and forth at a constant tilt angle has a constant width and extends along the outer periphery of the connected plate 31 in a central angle range of 120°, which is the range from one vertex to another vertex at two points ahead of the one vertex of the outer shape of connected plate 31 in the present embodiment.

A flat portion 312 is formed at the inner peripheral side of the connected plate 31 (inside of the three tilt plates 311). The flat portion 312 is substantially orthogonal to the front-back direction and has a hexagonal shape corresponding to the outer shape of the connected plate 31.

A main substrate 33 on which the main control circuit of the speaker device 1 etc. are mounted is arranged on the front face of the flat portion 312. The main substrate 33 is formed in a hexagonal outer shape corresponding to the flat portion 312. A circular hole 33a slightly larger than the outer diameter of the cylindrical portion 32 (a stepped portion 321 described later) is formed at the center. Fixation of the main substrate 33 is made by abutting (contacting) the front face of the flat portion 312 with the cylindrical portion 32 (the stepped portion 321 described later) being inserted in the hole 33a. Since the flat portion 312 of the inner case 3 having high heat dissipation property is in contact with the main substrate 33 in this manner, the heat generated at the main substrate 33 can be efficiently removed.

The cylindrical portion 32 is formed in a stepped shape, and the stepped portion 321 at its base end has larger diameter than the front portion.

The cylindrical portion 32 has a passive radiator (drone cone) 34 at the front end as an acoustic auxiliary portion for enhancing bass sound. The rear end of the cylindrical portion 32 is open so that internal space of the cylindrical portion 32 communicates with the main air chamber S1 at the back. This internal space is the sub air chamber S2 of the speaker device 1. In other words, the sub air chamber S2 is disposed on the side of the component arrangement space S3 with respect to the connected plate 31, and communicates with the main air chamber S1 through the cylindrical portion 32 formed in the inner case 3.

Since the cylindrical portion 32 protrudes from the inner case 3 forming the main air chamber S1 and has an internal space (the sub air chamber S2) communicating with the main air chamber S1 in this manner, the total volume of the air chambers of the entire speaker device 1 is increased and the acoustic performance (for example, sound quality of bass sound) is improved, as compared with a case where an acoustic auxiliary portion such as a passive radiator is simply disposed on a lateral face of the rear case 2.

Further, by providing the passive radiator 34 at the front end of the cylindrical portion 32 protruding toward the front, the passive radiator 34 can be arranged outside the main air chamber S1. As a result, bass sound enhancing effect by the passive radiator 34 can be obtained while the total volume of the air chambers are increased.

Further, the user can visually recognize the movement of the diaphragm of the passive radiator 34 at the time of sound output. As a result, the user visually perceives the bass sound enhancing effect by the passive radiator 34, as well as acoustically.

A portion of the cylindrical portion 32 ahead of the stepped portion 321 is a dial type switch (operation unit) 6 as a volume or mode selector.

As shown in FIGS. 4B and 6, the dial type switch 6 is provided with a dial substrate 61, a rotary encoder 62, a hollow shaft 63, and a dial knob 64, which are arranged around the cylindrical portion 32.

The dial substrate 61 is formed in an annular plate shape and is fixed by abutting (contacting at its surface) the stepped portion 321 of the cylindrical portion 32. A plurality of (twelve in the present embodiment) LEDs (Light Emitting Diodes) 611 is evenly arranged at the outer periphery of the dial substrate 61. A rotary encoder 62 of a hollow shaft type is surface-mounted on the dial substrate 61. A hollow shaft 63 is rotatably disposed on the outer periphery of the rotary encoder 62. A cylindrical dial knob 64 is fitted to the hollow shaft 63 so as to cover the front and the outer periphery of the hollow shaft 63. A decorative ring 641 is attached to the front face of the dial knob 64. A dial nameplate (not shown in the drawings) such as a scale plate is arranged on the face of the passive radiator 34 which closes the tip of the cylindrical portion 32.

With such a configuration, when the user rotates the dial knob 64 of the dial type switch 6 according to the present embodiment, the rotary encoder 62 detects a rotation amount or a rotation position thereof, so that the sound volume is changed or the acoustic mode is switched according to the rotation amount or the rotation position. The dial type switch 6 not only changes sound volume or switches acoustic mode, but executes any function realized by processing the electronic components (main substrate 33, LEDs 511, LEDs 611, etc.) arranged in the component arrangement space S3.

In this way, since the dial type switch 6 is disposed at the cylindrical portion 32 which protrudes to the front, good operation property of the dial type switch 6 can be ensured.

Further, since the dial substrate 61 is in contact with the stepped portion 321 of the inner case 3 having high heat dissipation property, the heat generated at the dial substrate 61 can be efficiently removed.

Further, at the tip (front end) of the dial type switch 6, the cylindrical portion 32 slightly protrudes from the dial knob 64 to the front (forward). Therefore, although a dial type switch protruding forward easily receives impact at the tip when it is hit against somewhere, the cylindrical portion 32 mainly receives the impact according to the above embodiment. Further, since there is a gap between the dial knob 64 and the dial substrate 61, the dial knob 64 does not contact the dial substrate 61 even when the dial knob 64 is pushed by the impact diagonally applied to the dial type switch 6. As a result, it is possible to reduce the impact on the dial knob 64, and to reduce the impact on the dial substrate 61 via the rotary encoder 62. Damages to the dial substrate 61 can be thereby suppressed.

As shown in FIGS. 2 and 4, the front case 4 is formed in a hexagonal outer shape corresponding to the flat portion 312 of the connected plate 31 of the inner case 3 when viewed from the front. The hexagonal outer shape of the front case 4 has a size approximately the same as that of the flat portion 312, and is arranged in front of the flat portion 312.

On the outermost portion of the front case 4 is erected an outer wall 41 substantially along the front-rear direction. The outer wall 41 is erected on the innermost portion of the front face of the tilt plates 311 of the connected plate 31 of the inner case 3. The front edge and the back edge of the outer wall 41 are each formed in a shape corresponding to the three tilt portions 21 at the front edge of the rear case 2 or corresponding to the three tilt plates 311 of the inner case 3. That is, although not shown in the drawings, the front edge and the back edge of the outer wall 41 are each formed in a sawtooth-like shape in the lateral view, since three tilt portions which tilt back and forth at a constant tilt angle are connected along the periphery and forms a ring. Each tilt portion extends over the central angle range of 120° in the front view, which is from one vertex to another vertex at two points ahead of the one vertex in the present embodiment. Therefore, the front edge face and the back edge face of the outer wall 41 are formed in parallel to each other.

A flat plate 42 substantially orthogonal to the front-back direction is disposed on the inner peripheral side of the outer wall 41 near the center of the outer wall 41 in the front-back direction. The flat plate 42 is disposed at approximately the same position in the front-back direction, as the front end of the stepped portion 321 of the cylindrical portion 32 of the inner case 3. The inner periphery of the flat plate 42 forms a circular hole 42a having a diameter slightly larger than the outer diameter of the stepped portion 321 of the cylindrical portion 32. The flat plate 42 is arranged so as to cover the front side of the main substrate 33 while the stepped portion 321 is inserted in the round hole 42a.

On the front face of the flat plate 42, there is erected a supporting wall 43 which supports transparent plates 45 described later. The supporting wall 43 is erected around the outer peripheral side of the dial substrate 61 and forms a regular hexagonal shape when viewed from the front.

The inner peripheral side of the supporting wall 43 of the front case 4 is an inner peripheral illuminant(s) L1.

At the inner peripheral illuminant L1, outer periphery of the dial substrate 61 is located in front of the flat plate 42 so that a plurality of LEDs 611 is exposed on the front side. An annular inner peripheral LED case 44 along the arrangement (rows) of the plurality of LEDs 611 is arranged in front of the plurality of LEDs 611. The inner peripheral LED case 44 has an opening in the front face to expose the plurality of LEDs on the front side. A surface treatment for suitably reflecting light from the plurality of LEDs 611 is performed on faces facing the plurality of LEDs 611 of the inner/outer peripheral wall erected on the inner/outer peripheral side of the plurality of LEDs 611. At the front edge of the inner peripheral wall of the inner peripheral LED case 44 and at the front edge of the supporting wall 43 of the front case 4, the transparent plates 45 of an annular plate shape are arranged so as to cover the front side of the plurality of LEDs 611. In the transparent plates 45, only the annular portion(s) located in front of the plurality of LEDs 611 is the light transmitting portion(s) 45a which transmits light.

With such a configuration, the inner peripheral illuminant L1 emits light from the plurality of LEDs 611 forward, through the light transmitting portion 45a in the transparent plate 45, so that light is emitted from the periphery of the dial type switch 6. According to the inner peripheral illuminant L1 of the present embodiment, the LED 611 corresponding to the rotation position of the dial type switch 6 (dial knob 64) emits light to display the rotation position.

The light-emitting unit 5 is arranged on the front face of the three tilt plates 311 of the connected plate 31 of the inner case 3, and constitutes an outer peripheral illuminant L2 which causes the speaker device 1 to emit light from the outer periphery of the front face.

Specifically, the light emitting unit 5 includes an outer peripheral LED case 51 and transparent plates (panels) 52 which transmit light.

The outer peripheral LED case 51 is formed in a shape corresponding to the three tilt plates 311 of the connected plate 31 of the inner case 3 when viewed from the front, and is arranged on the front faces of the three tilt plates 311 so as to be fitted between the outer wall 41 of the front case 4 and the rear case 2. Although not shown in the drawings, as well as the three tilt plates 311 of the connected plate 31, the outer peripheral LED case 51 is formed in a shape in which three tilt portions tilting back and forth at a constant tilt angle are connected along the outer periphery. The outer peripheral LED case 51 has an opening in the front face, and includes three LED substrates 512 at the bottom, on which a plurality of LEDs 511 are each mounted. The three LED substrates 512 are disposed corresponding to the three tilt plates 311 (that is, three illuminants 5a described later). The plurality of LEDs 511 is arranged in three parallel rows at different radial positions from each other, along the outer shape of the outer peripheral LED case 51. In the present embodiment, each of the LEDs 511 is a full-color LED on which chips of three colors (RGB: red, green, blue) are mounted. In the outer peripheral LED case 51 (that is, between the transparent plate 52 and the LED substrate 512), a partition plate(s) 513 is erected and partitions the rows of the plurality of LEDs 511 one by one. A surface treatment for suitably reflecting light from the plurality of LEDs 511 is performed on both faces of the partition plates 513, on faces facing the plurality of LEDs 511 of the inner peripheral wall and the outer peripheral wall, and the like. With the partition plate 513, light from the respective LEDs 511 is incident on different positions on the transparent plate 52 separately. That is, by each of the LEDs 511, light is incident (irradiation with high intensity is performed) only on a position corresponding to the LED 511 itself on the transparent plate 52 (the region in front of the LED 511 itself and which does not overlap the region in front of the other LEDs 511), and is not incident (irradiation with high intensity is not performed) on positions corresponding to other LEDs 511.

The transparent plates 52 are formed in a shape corresponding to the outer peripheral LED case 51 when viewed from the front, and is arranged so as to cover the front side of the outer peripheral LED case 51. The transparent plates 52 are provided so that light emitting surfaces of the transparent plates are not parallel to each other. More specifically, the transparent plate 52 tilts such that the radially inner side thereof is positioned slightly at the front side, and is arranged so as to form a plane which connects the tilt portions 21 at the front edge of the opening of the rear case 2 and the outer wall 41 of the front case 4. The transparent plate 52 is formed in a shape corresponding to the three tilt portions 21 at the front edge of the rear case 2 or corresponding to the three tilt plates 311 of the inner case 3. That is, the transparent plate 52 is formed in a shape in which three tilt plates 521 tilting back and forth at a constant tilt angle are connected along the periphery. Each of the tilt plates 521 extends over the central angle range of 120° when viewed from the front, which is the range from one vertex to another vertex at two points ahead of the one vertex in the present embodiment. The frontmost portion (a far edge which is farthest from the LEDs) of one of the tilt plates 521 is connected to the rearmost portion (a near edge which is nearest to the LEDs) of an adjacent tilt plate 521 via a step, so that the tilt plates 521 are connected to each other. Further, the transparent plate 52 has three rows of light transmitting portions 52a in each of the three tilt plates 521. The light transmitting portions 52a are disposed in front of and corresponding to the arrangement of the plurality of LEDs 511. In the transparent plate 52, only the light transmitting portions 52a transmit light. As a result, the surfaces of the three tilt plates 521 functions as the three light emitting surfaces 5a having respective main faces which emit light to the outside and are arranged at different angles from each other (arranged so as not to be parallel to each other). Here, the three light emitting surfaces 5a include the tilt portion 21 at the front edge of the opening of the rear case 2 and the outer wall 41 of the front case 4, and constitute the surface at the front edge of the outer periphery of the speaker device 1.

The transparent plate 52 is semitransparent and diffuses light from the LEDs 511 to form a light emitting surface on its face. By increasing the degree of diffusion (lowering the transparency), the brightness and the appearance of the light emitting surface can be uniform regardless of the direction from which the light emitting surface is viewed.

By increasing the transparency of the transparent plate 52, the brightness and the appearance of the light emitting surface cannot be uniform, but the room (for example, the ceiling etc.) in which the speaker device 1 is placed can be illuminated.

Further, the transparent plate 52 may be a half mirror made of highly transparent plate such as acrylic or polycarbonate having an inner face vapor-deposited with aluminum. Asa result, although the light from the inside is radiated to the outside through the transparent plate 52, the internal structure cannot be seen from the outside, and thereby improves designing characteristics.

The front face of the connected plate 31 of the inner case 3 may be formed as a flat plane (a plane perpendicular to the center axis Ax), with the three LED substrates 512 arranged perpendicular to the center axis Ax on the same plane, and each of the three tilt plates 521 of the transparent plate 52 tilting with respect to each of the LED substrates 512. In this case, the partition plates 513 are erected on the LED substrates 512 perpendicularly. The partition plates 513 are disposed at multiple positions and each have a length corresponding to the distance from the transparent plate 52 (tilt plates 521) to each of the LED substrates 512.

With such a configuration, the light emitting unit 5, that is, the outer peripheral illuminant L2, emits light from the plurality of LEDs 511 forward, through the light transmitting portions 52a of the transparent plate 52, so that light is emitted from three light transmitting portions 52a at the front side of the outer periphery of the speaker device 1. In the present embodiment, this outer peripheral illuminant L2 is a light emitting unit for a performance, for example, and the plurality of LEDs 511 emit light with colors, intensities and the like according to the acoustic mode or the like of the output sound.

Here, the three light emitting surfaces 5a have surfaces arranged at different angles (or directions) from each other, and are disposed around the dial type switch 6 protruding from the front surface 1a of the speaker device 1. Therefore, it is possible to visually recognize the light emitting surfaces 5a from a wide angle around the speaker device 1 (approximately 360° in the present embodiment) and to operate the dial type switch 6. As a result, as compared with the conventional device which provides good visibility of the indicator and good operation property of the operating unit only from a specific direction, the visibility of the light emitting surfaces 5a and the operation property of the dial type switch 6 can be improved.

Further, by setting the installation surface to the lower surface 2b or the rear surface 2e of the rear case 2, it is possible to change the direction of the front surface 1a provided with the dial type switch 6 to the lateral direction or the upward direction. As a result, excellent visibility of the light emitting surfaces 5a and the operation property of the dial type switch 6 can be obtained from any desired direction.

Further, as described above, each of the three light emitting surfaces 5a tilts with respect to the protruding direction of the dial type switch 6 (front direction), and a position P1 on a plane connecting the frontmost portions of the respective light emitting surfaces 5a is in front of the tip of the dial type switch 6. Therefore, even when the speaker device 1 falls on its front surface, for example, it is possible to prevent the dial type switch 6 from receiving impact because the three light emitting surfaces 5a mainly comes into contact with the floor or the like. As a result, damages to the dial substrate 61 connected to the dial knob 64 at the tip of the dial type switch 6 can be suppressed.

Further, a position P2 on a plane connecting the rearmost portions of the respective light emitting surfaces 5a is at the back of the tip of the dial type switch 6. (That is, the dial type switch 6 penetrates the plane.) Therefore, a user can easily hold the dial type switch 6 at the back of the tip of the dial type switch 6 through the three light-emitting surfaces 5a. The operation property of the dial type switch 6 can be thereby improved.

The number of the light-emitting surfaces 5a is not particularly limited as long as multiple light-emitting surfaces 5a are disposed, but it is preferable that at least three light-emitting surfaces 5a are disposed. Further, preferably, the plurality of light emitting surfaces 5a is evenly arranged around the dial type switch 6. As a result of these configurations, it is possible to more reliably prevent the dial type switch 6 from receiving impact.

Further, the shape (such as the tilt angle and the width) of the light emitting surface 5a is not particularly limited, and may be determined in accordance with a desired visible range, design, and the like.

As described above, according to the speaker device 1 of the present embodiment, three light emitting surfaces 5a each having a main surface which emit light to the outside are disposed around the dial type switch 6 disposed on the front surface 1a. The main surfaces of the three light emitting surfaces 5a are arranged at different angles (directions) from each other.

Therefore, it is possible to visually recognize the light emitting surfaces 5a from a wide angle around the speaker device 1 (approximately 360° in the present embodiment) and to operate the dial type switch 6. As a result, as compared with the conventional device which provides good visibility of the indicator and good operation property of the operating unit only from a specific direction, the visibility of the light emitting surfaces 5a and the operation property of the dial type switch 6 can be improved. In addition, since the light emitting surfaces 5a on the front face (the front surface 1a) can be visually recognized from the lateral side, it is not necessary to provide a light emitting portion on the side surfaces, and as a result, the number of parts can be reduced.

Further, by setting the installation surface to the lower surface 2b or the rear surface 2e of the rear case 2, it is possible to change the direction of the front surface 1a provided with the dial type switch 6 to the lateral direction or the upward direction. As a result, excellent visibility of the light emitting surfaces 5a and the operation property of the dial type switch 6 can be obtained from any desired direction.

Further, the dial type switch 6 protrudes from the front surface 1a. Each of the three light emitting surfaces 5a tilts with respect to the protruding direction of the dial type switch 6 (front direction), and the position P1 on a plane connecting the frontmost portions of the respective light emitting surfaces 5a is in front of the tip of the dial type switch 6.

Therefore, even when the speaker device 1 falls on its front surface, for example, it is possible to prevent the dial type switch 6 from receiving impact because the three light emitting surfaces 5a mainly comes into contact with the floor or the like. As a result, damages to the dial substrate 61 connected to the dial knob 64 at the tip of the dial type switch 6 can be suppressed. Therefore, since it is not necessary to provide components (such as a bumper) for avoiding or reducing the impact to the dial type switch 6, it is possible to reduce costs and improve designing characteristics.

Further, the position P2 on a plane connecting the rearmost portions of the respective light emitting surfaces 5a is at the back of the tip of the dial type switch 6.

Therefore, the user can easily hold the dial type switch 6 at the back of the tip of the dial type switch 6 through the three light-emitting surfaces 5a. The operation property of the dial type switch 6 can be thereby improved.

Next, an example of output control of musical tones from the loudspeaker 23 by the speaker device 1A and light emission control from the LEDs 511 and the LEDs 611 will be described.

In accordance with the operation of the operation unit 22 by the user, the CPU 71 reads musical tone data stored in the RAM 72 and causes the loudspeaker 23 to output musical tones according to the melody or the accompaniment represented by the read musical tone data.

In addition, the CPU 71 causes the loudspeaker 23 to output musical tones in accordance with the musical tone data, and at the same time causes the LEDs 511 and the LEDs 611 to emit light in a light emission pattern corresponding to the output musical tones.

For example, the light emission may be controlled in accordance with the reproduction (output) of the musical sound by sequentially reading light emission pattern data which is stored in advance corresponding to sections such as bars in musical tone data. Alternatively, the light emission pattern may be sequentially determined according to the scale, length, and the chord of the sound included in the musical sound data, and the operation content of the operation unit 22 by the user.

The CPU 71 controls each rows of the LEDs 511 partitioned by the partition plates 513 so that the rows emit light in different light emission patterns. Here, the different light emission patterns mean light emission patterns for different colors of light, different emission timings of light, or different emission timings for multiple colors of light.

For example, the outermost row among the multiple rows of the LEDs 511 is made to correspond to a vocal sound (melody) included in the musical tone data, the innermost row is made to correspond to a bass sound (accompaniment) included in the musical tone data, and multiple colors of light from the LEDs 511 are made to correspond to respective scales and/or respective sound volumes. Then, while reproducing sounds of the vocal sound (melody) and/or the bass sound (accompaniment) in a designated scale and volume, the CPU 71 causes the LEDs 511 in the corresponding row(s) to emit light in the corresponding color and timing in accordance with this musical tone data.

As described above, the partition plates 513 which partition the multiple rows of the LEDs 511 can prevent light from the LEDs 511 in each row from being incident on a position on the transparent plate (panel) 52, that is, on the same position where the light of the second light emitter is incident. Therefore, it is possible to divide a light emitting region of the transparent plate (panel) 52 into multiple regions which each emit light of different colors or at different timings.

### Modification Example

Next, a speaker device 1A which is a modification example of the above embodiment will be described. The same reference numerals are given to the same constituent elements as those in the above embodiment, and description thereof will be omitted.

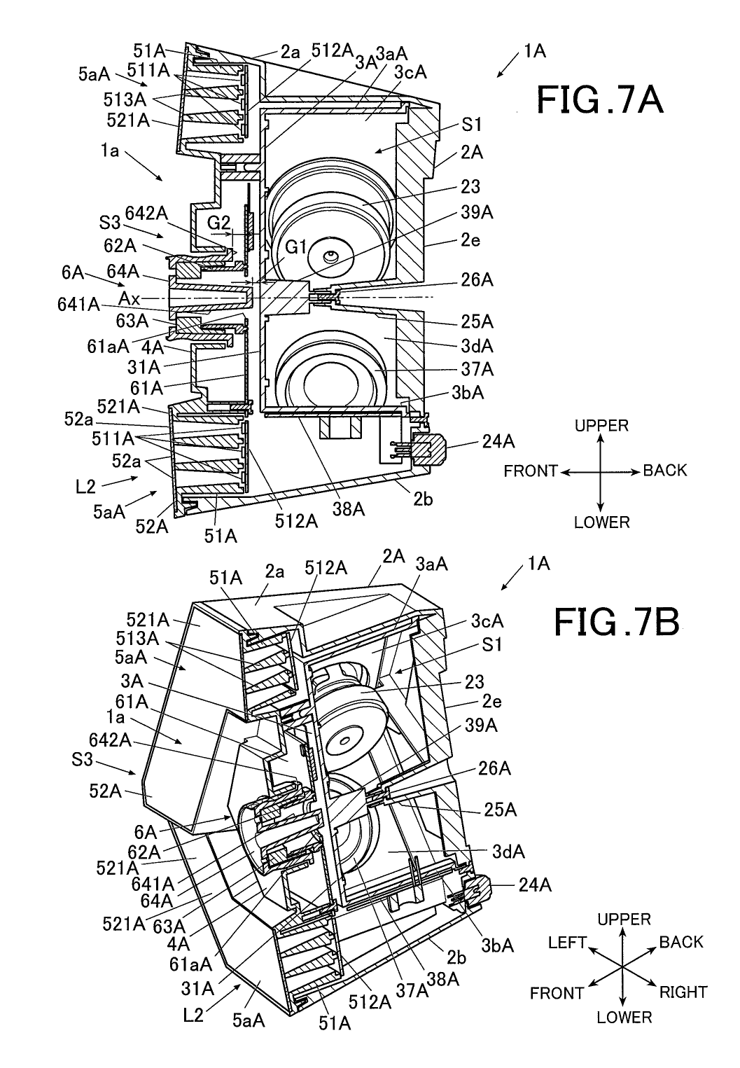

FIGS. 7A and B are sectional views of the speaker device 1A sectioned at the center in the left-right direction as in FIG. 4A. FIG. 7A is a lateral view and FIG. 7B is a perspective view of FIG. 7A as seen obliquely from the front.

As shown in FIGS. 7A and 7B, the speaker device 1A includes a rear case 2A, an inner case 3A, and a front case 4A.

Among them, the rear case 2A is formed in a substantially hexagonal truncated pyramid shape whose hexagonal shaped section in the front view gradually decreases toward the rear, as well as the rear case 2 of the above embodiment. The rear case 2A constitutes all the surfaces composing the outer face of the speaker device 1A except for the front surface 1a, that is, the upper surface 2a, the lower surface 2b, the two (left and right) upper side surfaces 2c, the two (left and right) side surfaces 2d, and the rear surface (back surface) 2e.

However, in the rear case 2A, the tilt portions 21 are not formed at the front edge of the opening. Further, the loudspeaker(s) 23 is not mounted on the upper side surface(s) of the rear case 2A, but mounted on the inner case 3A.

A power supply terminal (DC jack) 24 is disposed at the lower edge of the rear surface 2e of the rear case 2A. A fixing portion 25A for fixing the inner case 3A is erected forward from the center of the inner bottom (rear) surface of the rear case 2A.

The configurations of the rear case 2A other than the above are the same as those of the rear case 2 in the above embodiment.

The inner case 3A has a substantially flat connected plate 31A and six side plates erected backward from the periphery of the connected plate 31A, and has a shape opening toward the rear side. The connected plate 31A is a substantially flat plate formed in a hexagonal shape corresponding to the shape of the rear case 2A (opening shape) viewed from the front. The six side plates are each erected perpendicularly backward from the respective sides (edges) of the connected plate 31A.

The six side plates correspond to the respective six side surfaces of the rear case 2A, and each faces the corresponding side surface. Among these side plates, the two (left and right) upper side plates 3cA are each provided with a loudspeaker 23, and the two (left and right) lower side plates 3dA are provided with respective passive radiators 37A. The lower plate 3bA is formed so as to have a concave portion toward the radially inner side. A substrate 38A for the power supply terminal 24A is disposed at the concave portion. The passive radiators 37A may not be disposed on the lower side plates 3dA. Bass reflex ports may be formed without disposing the passive radiators 37A.

The opening on the rear side of the inner case 3A is closed by the bottom surface of the rear case 2A. As a result, a closed space including the loudspeakers 23 and the passive radiators 37A is defined by the rear case 2A and the inner case 3A. The closed space is an air chamber S1 of the speaker device 1A. In other words, the inner case 3A (the connected plate 31A) partitions the space in the rear case 2A into the air chamber S1 and the component arrangement space S3 in which electronic components other than the loudspeakers 23 and the passive radiators 37A are arranged.

In the inner case 3A, a boss 39A is erected from the center of the rear face of the connecting plate 31A. The fixing portion 25A of the rear case 2A is fitted to the tip (rear end) of the boss 39A, and fastened thereto with a screw 26A. Thus, the rear case 2A is firmly fixed to the inner case 3A so that the speaker box including them has improved rigidity and is not easily affected by externally applied force etc. Sound quality can be improved as a result.

The configurations of the inner case 3A other than the above are the same as those of the inner case 3 in the above embodiment.

A front case 4A is arranged inside of the rear case 2A, specifically in the component arrangement space S3.

At the center of the front face of the front case 4A is disposed a dial type switch (operation unit) 6A as a selector for volume or mode.

The dial type switch 6A is provided with a circuit substrate 61A, a rotary encoder 62A, a dial holder 63A, and a dial knob 64A.

The circuit substrate 61A includes a main control circuit of the speaker device 1A and the like, has a flat plate shape, and is fixed to the rear face of the front case 4A. At the center of the circuit substrate 61A, there is formed a circular hole 61aA in which a shaft 641A of the dial knob 64A can be inserted.

The rotary encoder 62A is a hollow shaft type and surface-mounted on the circuit substrate 61A. T dial holder 63A is rotatably disposed on the outer periphery of the rotary encoder 62A. The dial knob 64A has a substantially cylindrical shape and is fitted to the dial holder 63A so as to cover the front and the outer periphery of the dial holder 63A.

The shaft 641A protruding backward is disposed at the rotation center of the dial knob 64A, which is at the center of the rear face inside of the dial knob 64A. The shaft 641A is inserted in the hole 61aA of the circuit substrate 61A, through the inside of the dial holder 63A and the rotary encoder 62A. A first gap G1 is formed between the shaft 641A and the connected plate 31A of the inner case 3A in the front-rear direction. The rear edge of the outer periphery of the dial knob 64A, which is around the shaft 641A, functions as a support unit 642A which supports the rotary encoder 62A and has a diameter slightly larger than that of the rotary encoder 64A. A second gap G2 is formed between the support unit 642A and the circuit substrate 61A in the front-rear direction. The second gap G2 is larger than the first gap G1.

As described above, the second gap G2, which is larger than the first gap G1 between the connected plate 31A and the shaft 641A, is interposed between the circuit substrate 61A and the support unit 642A of the dial knob 64A. Therefore, when the dial type switch 6A is hit against somewhere and receives impact at its tip so that the dial knob 64A shifts backward, the shaft 641A of the dial knob 64A contacts the front face of the connected plate 31A first. Therefore, it is possible to reduce the impact on the circuit substrate 61A transmitted via the dial knob 64A by preventing the support unit 642A of the dial knob 64A from contacting the circuit substrate 61A. However, when the dial knob 64A receives the impact, the impact is transmitted to the circuit substrate 61A via the dial holder 63A and the rotary encoder 62A. The first gap G1 is set between the shaft 641A and the connected plate 31A, so that the shaft 641A of the dial knob 64A contacts the front face of the connected plate 31A before the impact transmitted as described above exceeds a predetermined level allowed for the circuit substrate 61A.

Further, the second gap G2 may be smaller than the first gap G1, as long as the deflection amount of the circuit substrate 61A pushed by the support unit 642A is not so much as to damage the circuit substrate 61A. In other words, even when the rotary encoder 62A pushed by the dial knob 64A comes into contact with the circuit substrate 61A, the resulting deflection amount of the circuit substrate 61A is acceptable as long as the circuit substrate 61A is not damaged.

The front side of the outer periphery of the front case 4A constitutes an outer peripheral illuminant L2.

In the outer peripheral illuminant L2, an LED case 51A is disposed at the outer periphery of the front case 4A.

The front side of the LED case 51A is formed in a shape corresponding to the opening of the rear case 2A when viewed from the front. The front side of the LED case 51A is open. To the back side of the LED case 51A is fixed a LED substrate 512A on which a plurality of LEDs 511A is mounted. The plurality of LEDs 511A is arranged in three parallel rows at different radial positions from each other, along the outer shape of the LED case 51A. In the LED case 51A, partition plate(s) 513A are erected so as to partition the rows of the plurality of LEDs 511A one by one. A surface treatment for suitably reflecting light from the plurality of LEDs 511A is performed on both faces of the partition plates 513A, on faces facing the plurality of LEDs 511A of the inner peripheral wall and the outer peripheral wall, and the like. The partition plates 513A are formed such that its thickness gradually decreases toward the front. With the partition plates 513A, light from the respective LEDs 511A is incident on different positions on the transparent plate 52A separately. That is, the partition plates 513A play a role of preventing light emitted from the LEDs 511A adjacent to each other from being incident on a position on the transparent plate (panel) 52A, that is, on the same position where the light of the second light emitter is incident.

The opening on the front side of the LED case 51A is covered with the transparent plate 52A. The transparent plate 52A tilts so that the radially inner side thereof is positioned slightly at the front side, and is formed in a shape corresponding to the LED case 51A when viewed from the front. This transparent plate 52A is formed in a shape in which three tilt plates 521A tilting back and forth at a constant tilt angle are connected along the outer periphery. Each tilt plate 521A extends over the central angle range of 120° when viewed from the front, which is the range from one vertex to another vertex at two points ahead of the one vertex in the present embodiment. The frontmost portion of one of the tilt plate 521A is connected to the rearmost portion of an adjacent tilt plate portion 521A via a step. The tilt plates 521A are thereby connected to each other. As a result, the surfaces of the three tilt plates 521A functions as the three light emitting surfaces 5aA having respective main faces to emit light to the outside and are arranged at different angles from each other.

The configurations of the front case 4A other than the above are the same as those of the front case 4 in the above embodiment.

The speaker device 1A having the above configurations also exhibits the same effect as the speaker device 1 in the above embodiment.

Although some embodiments of the present invention have been described above, it goes without saying that the present invention is not limited to them, and various modifications can be made without departing from the gist of the invention.

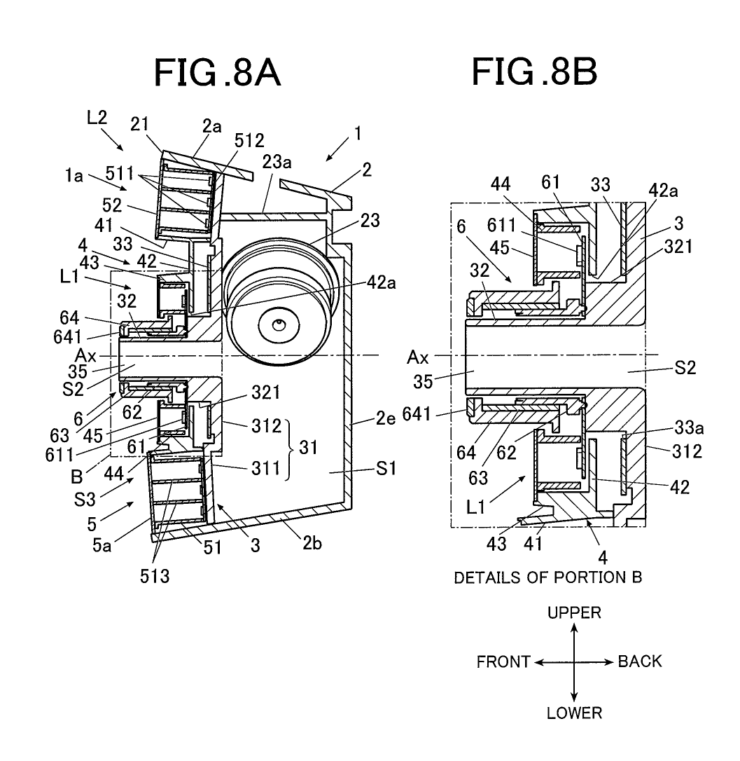

For example, the passive radiator 34 is disposed at the tip of the cylindrical portion 32 in the above embodiment, however, instead of the passive radiator 34, a bass reflex port 35 may be formed as an acoustic auxiliary portion as shown in FIGS. 8A and 8B. In this case, the tip of the cylindrical portion 32 may be open so that the cylindrical portion 32 forms at least a part of the bass reflex port 35. Further, by extending the cylindrical portion 32 backward from the rear face of the inner case 3, the length of the bass reflex port 35 (bass reflex duct) may be adjusted according to the desired bass sound enhancing effect.

As a result, the bass reflex port 35 can be formed outside of the main air chamber S1. Then, unlike the case where a bass reflex port is formed on a side surface of the rear case 2, it is possible to achieve bass sound enhancing effect by the bass reflex port 35 without pressing the main air chamber S1.

Further, since the side surfaces can be freely designed as compared with the case where a bass reflex port is formed on a side surface (for example, on the lower side surface 2d) of the rear case 2, it is possible to more freely design the shape and to arrange layout of parts.

Further, when the bass reflex port 35 is formed, an air flow generated in the main air chamber S1 and the sub air chamber S2 further enhances heat radiation effect of the inner case 3 made of a material having high heat dissipation property. Therefore, it is possible to remove the heat of the main substrate 33 and the dial substrate 61 which are in contact with the inner case 3 more efficiently. In this case, although not shown in the drawings, a heat dissipation fin is preferably disposed near the opening of the bass reflex port 35 in the main air chamber S1 of the inner case 3. Further, a grill (not shown in the drawings) may be disposed at the bass reflex port 35 on the front side.

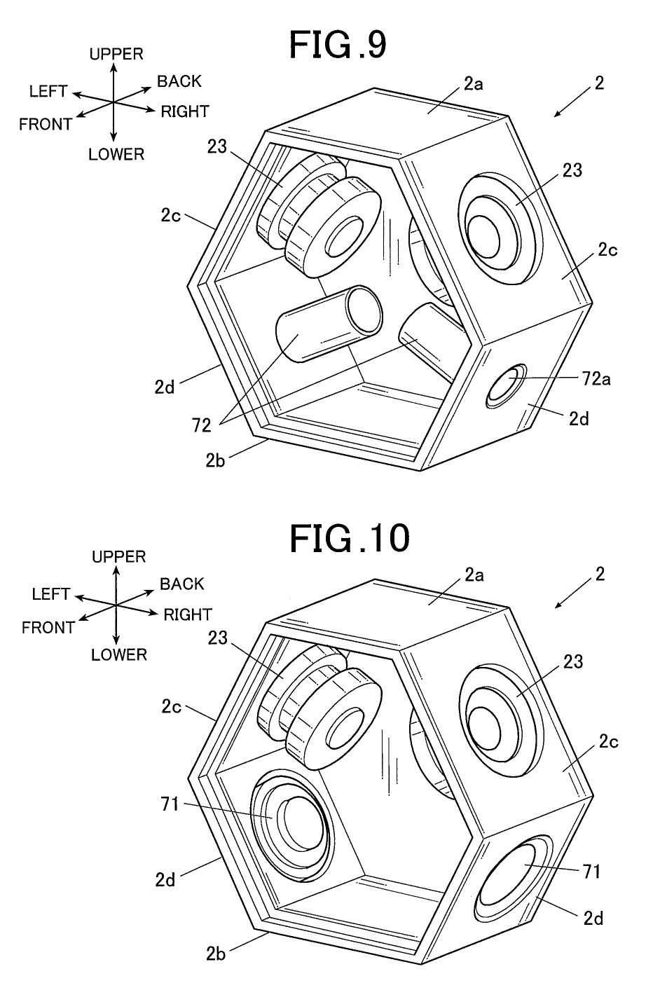

In the case where the bass reflex port 35 is formed in the cylindrical portion 32 instead of the passive radiator 34, as shown in FIG. 9, bass reflex ports 72a may be formed on the two (left and right) lower side surfaces 2d of the rear case 2. Bass reflex ducts 72 each having the bass reflex port 72a may be erected in the main air chamber S1. As a result, bass sound enhancing effect by the bass reflex port can be further improved.

As well as FIG. 3, FIG. 9 is a view schematically showing arrangement of the loudspeakers 23 and the like on the side surfaces of the rear case 2, and does not show arrangement of the bass reflex ports 72a (the bass reflex ducts 72) accurately. To be exact, the bass reflex ports 72a (the bass reflex ducts 72) are each formed at a fixing plate (not shown in the drawings) erected perpendicularly from the edge of the inner bottom (rear) surface of the rear case 2 at the lower side surface 2d side, as well as the loud speaker 23 described above. A number of sound holes (not shown in the drawings) are formed in the lower side surface 2d outside of the fixing plate, and sound from the bass reflex port 72a is output to the outside of the rear case 2 through these sound holes. In such cases, a rib (not shown in the drawings) is erected on the outer face of the fixing plate at both sides of the bass reflex port 72a in the peripheral direction. The rib closes a gap between the tilting lower side surface 2c and the fixing plate.

Further, in the case where the passive radiator 34 is disposed at the cylindrical portion 32, as shown in FIG. 10, additional passive radiators 71 may be disposed on the two (left and right) lower side surfaces 2d of the rear case 2. As a result, bass sound enhancing effect by the bass reflex port can be further improved.

The passive radiator 71 may be disposed on any of the surfaces of the rear case 2 which define the main air chamber S1, except for the upper side surface(s) 2c on which the loudspeaker(s) 23 is disposed. However, the passive radiator 71 is preferably disposed on a surface other than the lower surface 2b and the rear surface 2e, which may be the installation surfaces.

Further, the shape and the like of the cylindrical portion 32 is not particularly limited, as long as it protrudes from the inner case 3 and includes a sub air chamber S2 communicating with the main air chamber S1. The cylindrical portion 32 may have a rectangular cross section, or may be curved or bent.

Further, the dial type switch 6 may be another kind of operation unit, as long as it is disposed at the cylindrical portion 32.

Further, in the above embodiment, vibration of the inner case forming the air chamber may be prevented from being transmitted to the front case by using a vibration isolating member such as rubber at a connecting portion between the front case and the inner case.

Further, in the above embodiments, an example of the electronic device according to the present invention is applied to a speaker device (speaker system), however, the electronic device according to the present invention may be devices other than a speaker device, as long as the outer face provided with the operation portion has a light emitting portion.

1. An electronic device comprising:
multiple light transmissive panels which are provided so that light emitting surfaces of the panels are not parallel to each other;
a plurality of light emitters which includes a first light emitter and a second light emitter, the first light emitter and the second light emitter being provided corresponding to one of the panels and each radiating light to out of the electronic device through the one of the panels; and
a partition plate which is erected between the first light emitter and the second light emitter so that the partition plate prevents the light of the first light emitter from being incident on a position on the one of the panels where the light of the second light emitter is incident.

2. The electronic device according to claim 1, wherein a color of the light from the first light emitter is different from a color of the light from the second light emitter.

3. The electronic device according to claim 1, further comprising a controller which causes the first light emitter and the second light emitter to emit light at different timing from each other.

4. The electronic device according to claim 1,
wherein the panels are arranged to form a ring,
wherein the plurality of light emitters is arranged in multiple parallel rows which are along the ring and which are at different radial positions from each other in a radial direction, the radial direction being an outward direction from a center of the ring, and
wherein the partition plate partitions the rows one by one.

5. The electronic device according to claim 1, further comprising an operation unit,
wherein the panels are arranged to form a ring around the operation unit.

6. The electronic device according to claim 1, further comprising multiple circuit substrates on which the plurality of light emitters is mounted,
wherein the multiple circuit substrates each correspond to each of the panels and is arranged at an angle corresponding to the each of the panels.

7. The electronic device according to claim 1, further comprising multiple circuit substrates on which the plurality of the light emitters is mounted,
wherein the multiple circuit substrates each correspond to each of the panels, and
wherein the multiple circuit substrates are arranged on a plane which faces a direction different from the panels.

8. The electronic device according to claim 6,
wherein the partition plate is erected perpendicularly from one of the circuit substrates which corresponds to the at least one of the panels, and
wherein a length of the partition plate corresponds to a distance from the at least one of the panels to the one of the circuit substrates.

9. The electronic device according to claim 5,
wherein a tip of the operation unit protrudes from an outer face of the electronic device in a protruding direction,
wherein the panels each tilt with respect to the protruding direction,
wherein the operation unit does not penetrate a plane which connects respective ends of the panels in the protruding direction, and
wherein the operation unit penetrates a plane which connects respective ends of the panels in a direction opposite to the protruding direction.

10. The electronic device according to claim 5, wherein the operation unit is a dial type switch including:
a dial knob disposed around a tip of the operation unit; and
a dial substrate disposed at a base end of the operation unit and connected to the dial knob.

11. The electronic device according to claim 5,
wherein the panels include at least three panels, and
wherein the panels are evenly arranged around the operation unit.

12. The electronic device according to claim 1,
wherein the panels each tilt at a constant tilt angle with respect to a reference plane and extend along an outer periphery of an outer face of the electronic device,
wherein each of the panels each has a far edge which is farthest from the light emitters corresponding to the each of the panels, and a near edge which is nearest to the light emitters corresponding to the each of the panels, and
wherein the far edge of one of the panels is connected to the near edge of another of the panels via a step, the one panel being adjacent to the another of the panels.

13. The electronic device according to claim 5, further comprising:
an outer face which includes multiple surfaces arranged at different angles from each other;
a user interface which is disposed on one of the surfaces and includes the operation unit and the panels; and
a speaker unit which is disposed on another of the surfaces.

14. The electronic device according to claim 13, wherein the surfaces individually include a surface on which a speaker unit is disposed, a surface on which a user interface is disposed, and an installation surface.

15. The electronic device according to claim 13, wherein the surfaces individually include two surfaces on which a user interface is each disposed, and two installation surfaces.

16. The electronic device according to claim 13, wherein the surfaces individually include two surfaces on which a speaker unit is each disposed, two surfaces on which an acoustic auxiliary portion is each disposed, two surfaces on which a user interface is each disposed, and two installation surfaces.

17. The electronic device according to claim 13, further comprising:
a first acoustic part which forms a first air chamber surrounded by multiple surfaces including a surface on which a speaker unit is disposed; and
a second acoustic part which protrudes from the first acoustic part, includes a second air chamber communicating with the first air chamber,
wherein the operation unit is disposed at the second acoustic part.

18. The electronic device according to claim 17, further comprising a partition member which partitions an internal space of the electronic device into a component arrangement space and the first air chamber,
wherein the circuit substrate is disposed in the component arrangement space.

19. The electronic device according to claim 13, further comprising a controller which causes the speaker unit to output musical tones in accordance with an operation of the operation unit.
